(19) United States
(12) Patent Application Publication
(10) Pub. No.: US 2014/0122753 A1
(43) Pub. Date: May 1, 2014

(54) Electronic Device, Management Method Thereof, and Rack Serving System

(71) Applicants: INVENTEC (PUDONG) TECHNOLOGY CORPORATION, Shanghai (CN); INVENTEC CORPORATION, Taipei City (TW)

(72) Inventors: Kuo-Shu CHIU, Taipei City (TW); Chien-Chou CHEN, Taipei City (TW); Yu-Hui WANG, Taipei City (TW); Jo-Yu CHANG, Taipei City (TW)

(73) Assignees: INVENTEC CORPORATION, Taipei City (TW); INVENTEC (PUDONG) TECHNOLOGY CORPORATION, Shanghai (CN)

(21) Appl. No.: 13/846,771

(22) Filed: Mar. 18, 2013

(30) Foreign Application Priority Data
Oct. 31, 2012 (CN) 201210428249.3

(51) Int. Cl. G06F 3/06

(52) U.S. Cl. CPC G06F 3/0653; G06F 3/061; G06F 3/0689
USPC 710/74

(57) ABSTRACT

An electronic device, a management method thereof, and a rack serving system are presented. A management interface packet is transferred to a second connection port of a storage interface through a first connection port of a baseboard management controller (BMC). Also, a hard disk drive (HDD) controller of the storage interface converts the management interface packet into an internal control command that conforms to the storage interface, so as to read the system environment information according to the internal control command. Additionally, the HDD controller encapsulates the system environment information into a response packet, and transfers the response packet to the first connection port of the BMC through the second connection port.

### CROSS-REFERENCE TO RELATED APPLICATIONS

This non-provisional application claims priority under 35 U.S.C. §119(a) on Patent Application No(s). 201210428249.3 filed in China, P.R.C. on Oct. 31, 2012, the entire contents of which are hereby incorporated by reference.

### BACKGROUND OF THE INVENTION

1. Technical Field of the Invention

The disclosure relates to a monitoring mechanism of an electronic device, more particularly to an electronic device capable of monitoring a storage unit in real time and a management method thereof.

2. Description of the Related Art

In the computer field, a computer server has a high computational capability and is capable of providing a variety of functions for use by several users at the same time. Therefore, the selection standard of a hardware device for a computer server is different from a common personal computer. The hardware device of a computer server is required to be capable of handling a heavy load and have a long service life. Thereby, data loss on a computer server caused by hardware damages during the execution of computational work can be avoided. As the dedicated disk drive for a computer server is very expensive and has a limited storage space, the disk drive in an existing computer server usually adopts a hard disk drive (HDD) array formed of a plurality of physical disk drives.

Generally speaking, the firmware of the storage card on a printed circuit board (PCB) can only provide storage device information, but does not provide system environment information such as temperature and voltage of downstream devices thereof such as a redundant array of independent disks (RAID) controller, an expander, a just a bunch of disks (JBOD) system or does not provide nonstandard commands in the industry. Therefore, vulnerability in real-time monitoring for the external control of the integrated environment may occur.

### SUMMARY OF THE INVENTION

In an embodiment, the disclosure provides an electronic device comprising a storage unit, a baseboard management controller (BMC) and a storage interface. The baseboard management controller (BMC) comprises a first connection port. The first connection port is configured for transferring a management interface packet. The storage interface is coupled to the storage unit. The storage interface comprises a second connection port and a hard disk drive (HDD) controller. The second connection port is coupled to the first connection port and is configured for receiving the management interface packet. The hard disk drive (HDD) controller is coupled to the second connection port, and is configured for converting the management interface packet into an internal control command that conforms to the storage interface, so as to read a system environment information according to the internal control command. The hard disk drive (HDD) controller also encapsulates the system environment information into a response packet and transferring the response packet to the first connection port of the BMC through the second connection port. The response packet conforms to the format of the management interface packet.

The disclosure further provides a management method configured for an electronic device. In this method, a management interface packet is transferred to a second connection port of a storage interface through a first connection port of a baseboard management controller (BMC). The storage interface comprises a hard disk drive (HDD) controller, and the storage interface is coupled to a storage device. The management interface packet is converted into an internal control command that conforms to the storage interface by the HDD controller, so as to read a system environment information according to the internal control command. The system environment information is encapsulated into a response packet by the HDD controller. The response packet is transferred to the first connection port of the BMC through the second connection port. The response packet conforms to the format of the management interface packet.

A rack serving system is further disclosed. The rack serving system comprises a rack management server, a storage unit and a storage interface. The rack management server comprises a baseboard management controller (BMC). The baseboard management controller (BMC) comprises a first connection port. A management interface packet is transferred through the first connection port. The storage interface is coupled to the storage unit. The storage interface comprises a second connection port coupled to the first connection port and a hard disk drive (HDD) controller. The second connection port is configured for receiving the management interface packet. The hard disk drive (HDD) controller is coupled to the second connection port, and is configured for converting the management interface packet into an internal control command that conforms to the storage interface, so as to read a system environment information according to the internal control command. The hard disk drive (HDD) controller also encapsulates the system environment information into a response packet and transferring the response packet to the first connection port of the BMC through the second connection port. The response packet conforms to the format of the management interface packet.

### BRIEF DESCRIPTION OF THE DRAWINGS

The disclosure will become more fully understood from the detailed description given herein below for illustration only, thus does not limit the disclosure, wherein:

FIG. 1 is a block diagram of an electronic device according to an embodiment of the disclosure;

FIG. 2 is a flow chart of a management method according to an embodiment of the disclosure;

FIG. 3 is a block diagram of an electronic device according to another embodiment of the disclosure; and

FIG. 4 is a block diagram of a rack serving system according to an embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

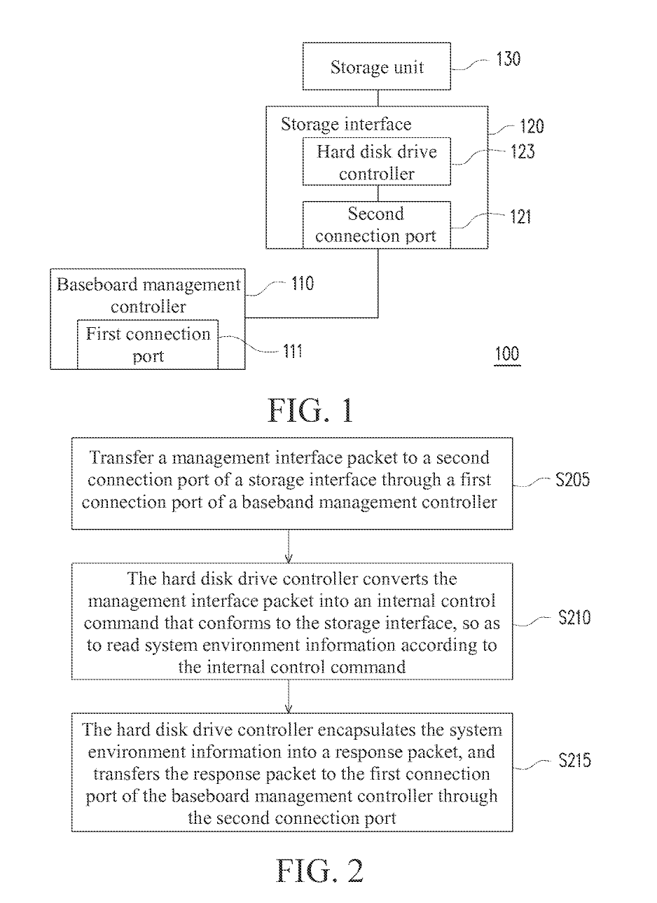

FIG. 1 is a block diagram of an electronic device according to an embodiment of the disclosure. Referring to FIG. 1, an electronic device 100 comprises a BMC 110, a storage interface 120, and a storage unit 130. The BMC 110 comprises a first connection port 111.

The storage interface 120 comprises a second connection port 121 and an HDD controller 123. The storage interface 120 is coupled to the storage unit 130. Through the first connection port 111, the BMC 110 is connected to the second connection port 121 of the storage interface 120.

The BMC 110 does not depend on the processor, Basic Input/Output System (BIOS) or the operating system of the electronic device 100 to operate. The BMC 110 is an independent subsystem that operates in the electronic device 100, which is often an independent circuit board installed on the motherboard. After starting the execution, the BMC 110 starts a monitoring procedure. Subsequently, the BMC 110 starts to transfer a management interface packet to the storage interface 120, so as to obtain system environment information of the storage interface 120. Next, the BMC 110 determines whether an error occurs in the received system environment information, in order to perform corresponding measures.

The HDD controller 123 is configured for managing a physical storage unit 130, so that a central processing unit (not shown) is capable of communicating with the storage unit 130. The HDD controller 123 comprises firmware, and the firmware drives the HDD controller 123. When being started, the storage interface 120 first initialize the firmware of the HDD controller 123. Subsequently, when the storage interface 120 receives the management interface packet, and the HDD controller 123 converts the management interface packet into an internal control command that conforms to the storage interface 120, so as to read the system environment information according to the internal control command, and also, encapsulates the system environment information into a response packet and transfers the response packet to the first connection port 111 of the BMC 110 through the second connection port 121. The response packet conforms to the format of the management interface packet.

The storage unit 130 is, for example, a logical disk array such as a RAID or JBOD system. A plurality of HDDs is capable of being combined into one logical disk array. Alternatively, the storage unit 130 is a nonvolatile storage device such as an HDD.

Additionally, in other embodiments, the storage interface 120 is also permitted to be coupled to a plurality of storage units 130. The BMC 110 is capable of transferring a management interface packet for different storage units 130.

FIG. 2 is a flow chart of a management method according to an embodiment of the disclosure. Please refer to FIG. 1 and FIG. 2 at the same time. In Step S205, a management interface packet is transferred to the second connection port 121 of the storage interface 120 through the first connection port of the BMC 110. Here, the format of the management interface packet and the response packet is an IPMI packet.

After the storage interface 120 receives the management interface packet, in Step S210, the HDD controller 123 converts the management interface packet into an internal control command that conforms to the storage interface 120, so as to read system environment information according to the internal control command. For example, a storage space is configured in the storage interface 120, so as to store the system environment information read from the storage unit 130, or to detect the system environment information acquired by the storage unit 130.

The system environment information comprises an electric state, an HDD state, an error state, sensor information, disk array information, and FRU information of the storage unit 130 or a combination thereof. The electric state comprises a power supply state and a voltage state, for example, information such as the power supply of the storage unit being turned on or off or the voltage value. The HDD information is, for example, the usable space and the used space of the HDD. The sensor information is, for example, system temperature or the value read by the sensor. The disk array information is, for example, the type of disk array, and for a RAID system, the RAID system comprises a plurality of different levels. The FRU information is, for example, a hardware type, a manufacturer identification code, the serial number of a used slot or a hardware specification.

Subsequently, in Step S215, the HDD controller 123 encapsulates the system environment information into a response packet, and transfers the response packet to the first connection port 111 of the BMC 110 through the second connection port 121. The response packet conforms to the format of the management interface packet.

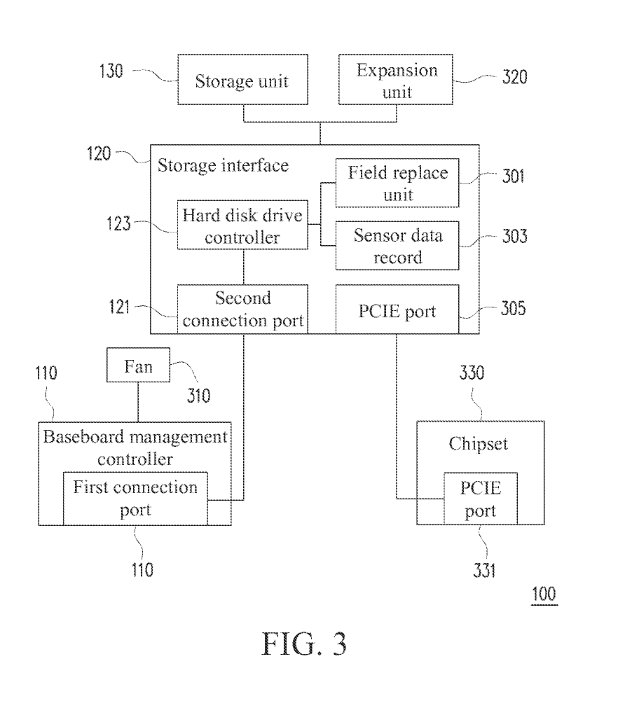

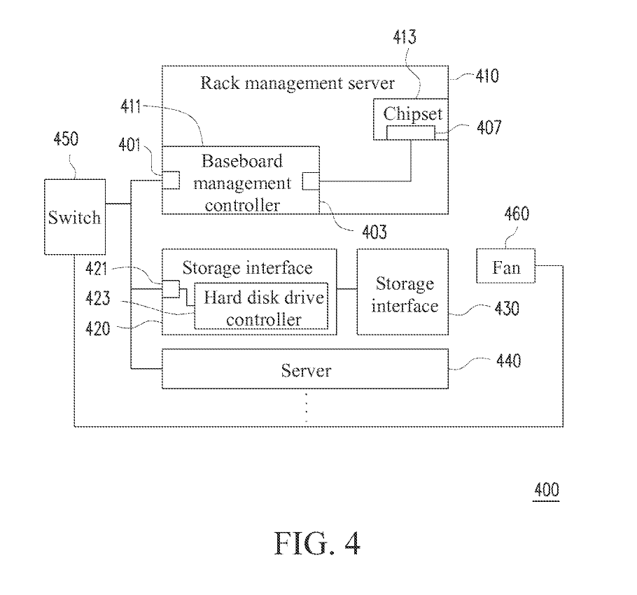

Additionally, the storage interface 130 is capable of being inserted in the chipset. FIG. 3 is a block diagram of an electronic device according to another embodiment of the disclosure. In this embodiment, the electronic device 100 in FIG. 1 is used for illustration, the components having the same functions are marked with the same symbols, and the relevant illustration is omitted.

Please refer to FIG. 3. In this embodiment, the electronic device 100 further comprises a chipset 330 and an expansion unit 320. Also, the chipset 330 comprises a Peripheral Component Interconnection Express (PCIE) port 331. The storage interface 120 also comprises a PCIE port 305, and the storage interface 120 is inserted in the PCIE port 331 of the chipset 330 through the PCIE port 305.

The chipset 330 is, for example, a southbridge chip or a circuit that integrates the functions of a southbridge chip and a northbridge chip. Generally speaking, the chipset 330 is coupled to a central processing unit (not shown). Additionally, the chipset 330 is also capable of being coupled to the BMC 110.

Additionally, the storage interface 120 further comprises an FRU 301 and a sensor data record (SDR) 303. The FRU 301 is, for example, a detailed list configured for storing replaceable equipment acquired from the storage unit 130, such as a supplier identification code and a manufacturer. The SDR 303 records the attribute data provided by an individual sensor which might be built in the storage unit 130 inside the storage unit 130, for example, a system temperature sensor, a fan rotational speed sensor or a current sensor.

The illustration is given below with regard to the current technologies. It is assumed that the first connection port 111 and the second connection port 121 are both I²C ports, the first connection port 111 and the second connection port 121 are coupled through an I²C bus, and the management interface packet and the response packet are both IPMI packets.

In terms of hardware configuration, a group of I²C ports of the BMC 110 is used as the first connection port 111, and a group of I²C ports of the storage interface 120 is used as the second connection port 121. The first connection port 111 and the second connection port 121 are connected through a I²C bus.

The processing signal mechanism of the firmware for the HDD controller 123 and the BMC 110 is as follows. The BMC 110 transfers an IPMI packet to the storage interface 120 through an I²C bus, and upon reception, the storage interface 120 is required to generate a processing mechanism. That is, the HDD controller 123 parses the data content of the IPMI packet and analyzes the received packet regarding the header, data content and verification thereof, so as to learn the information contained in the IPMI packet, which is further converted into an internal control command that conforms to the format supported by the storage interface 120. Thereby, the HDD controller 123 is capable of adopting an existing command manner, for example, a Small Computer System Interface (SCSI) or a Serial attached SCSI (SAS) command, of the storage interface 120 to drive the storage unit 130 or the expansion unit 320, so as to retrieve the system environment information, such as the voltage value, the rest space of the HDD, the configuration information of the HDD, of the storage unit 130 or expansion unit 320. Subsequently, the storage interface 120 encapsulates the acquired system environment information into an IPMI packet. The IPMI packet is responded to the BMC 110 through an I²C bus.

Subsequently, the BMC 110 informs a user of the condition of the storage unit 130 with the collected system environment information through a user interface such as a web interface. Therefore, the processing reaction mechanism is capable of becoming automatic through the BMC 110 for the system environment information. For example, when the system temperature of the storage unit 130 is higher than or equal to a preset temperature. That is, when the system temperature is too high, the BMC 110 is capable of automatically turning up the rotational speed of the fan 310 to reduce the temperature of the storage unit 130. That is to say, the BMC 110 directly sends a control signal to the fan 310, so as to control the rotational speed of the fan 310.

Additionally, the method is also applicable to a rack serving system, which is illustrated below through further examples.

FIG. 4 is a block diagram of a rack serving system according to an embodiment of the disclosure. Referring to FIG. 4, a rack serving system 400 comprises a rack management server 410, a storage interface 420, a storage unit 430, a server 440, a switch 450, and a fan 460. The rack management server 410, the storage interface 420, the storage unit 430, the server 440, and the fan 460 are all coupled to the switch 450, so as to perform communication through the switch 450. In this embodiment, only one server 440 is listed, but the disclosure is not limited thereto. In other embodiments, the rack serving system 400 comprises two or more servers 440.

The rack management server 410 comprises a BMC 411, and the BMC 411 comprises a first connection port 401, so as to transfer a management interface packet through a first connection port 401. Additionally, the rack management server 410 further comprises a chipset 413. The chipset 413 is connected, through a connection interface 407 such as a PCIE port, to the connection interface 403 (for example, a PCIE port) of the BMC 411.

The storage interface 420 is coupled to the storage unit 430. Also, the storage interface 420 comprises a second connection port 421 and an HDD controller 423. The second connection port 421 is coupled to the first connection port 401 and configured for receiving a management interface packet. The HDD controller 423 is coupled to the second connection port 421 and is configured for converting the management interface packet into an internal control command that conforms to storage interface 420, so as to read the system environment information according to the internal control command, and also encapsulates the system environment information into a response packet and transfers the response packet to the first connection port 401 of the BMC 411 through the second connection port 421. The response packet conforms to the format of the management interface packet.

In this embodiment, the first connection port 401 and the second connection port 421 are both I²C ports, that is, the first connection port 401 and the second connection port 421 are coupled through an I²C bus, and the management interface packet and the response packet are both IPMI packets. The processes of receiving and sending an IPMI packet in this embodiment are similar to those in the description of FIG. 3, which are no longer described here. Further, in this embodiment, the BMC 411 communicates with the fan 460 through the switch 450, for example, the BMC 411 transfers a control signal to the fan 460 through the switch 450.

In conclusion, the BMC is coupled to the second connection port, for example, an I²C port, in the storage interface through the first connection port, for example, an I²C port, so as to directly read the system environment information of the storage unit from the storage interface through the BMC. Therefore, the system environment information acquired by the HDD controller becomes more accurate, because the acquired system environment information is detected by a sensor disposed inside the storage unit rather than by a sensor configured outside the storage unit. Additionally, the BMC is further capable of recording the acquired system environment information to achieve the convience for users to check later. Additionally, the BMC and the storage interface are further capable of transmission and communication by using a packet in an IPMI format at the same time, which not only has a safety and verification mechanism, but also is capable of enhancing the future consistency and expansibility at the same time.

What is claimed is:

1. An electronic device, comprising:
a storage unit;
a baseboard management controller (BMC), comprising:
a first connection port configured for transferring a management interface packet; and
a storage interface coupled to the storage unit, and the storage interface comprising:
a second connection port coupled to the first connection port, and configured for receiving the management interface packet; and
a hard disk drive (HDD) controller, coupled to the second connection port, and configured for converting the management interface packet into an internal control command that conforms to the storage interface, so as to read a system environment information according to the internal control command, and encapsulating the system environment information into a response packet and transferring the response packet to the first connection port of the BMC through the second connection port, wherein the response packet conforms to the format of the management interface packet.

2. The electronic device according to claim 1, further comprising:
a fan coupled to the BMC;
wherein the BMC transfers a control signal to the fan, so as to control rotational speed of the fan.

3. The electronic device according to claim 1, wherein the HDD controller comprises a firmware, and the firmware drives the HDD controller.

4. The electronic device according to claim 1, further comprising a chipset, wherein the storage interface is inserted in the chipset.

5. The electronic device according to claim 1, wherein the system environment information comprises an electric state, an HDD state, an error state, a sensor information, a disk array information, and a field replace unit (FRU) information of the storage unit or a combination thereof

6. The electronic device according to claim 1, wherein the first connection port and the second connection port are both Inter-Integrated Circuit (I2C) ports, the first connection port and the second connection port are coupled through an I2C bus, and the management interface packet and the response packet are both Intelligent Platform Management Interface (IPMI) packets.

7. A management method configured for an electronic device, the management method comprising:
transferring a management interface packet to a second connection port of a storage interface through a first connection port of a baseboard management controller (BMC), wherein the storage interface comprises a hard disk drive (HDD) controller, and the storage interface is coupled to a storage device;
converting the management interface packet into an internal control command that conforms to the storage interface by the HDD controller, so as to read a system environment information according to the internal control command; and
encapsulating the system environment information into a response packet by the HDD controller, and transferring the response packet to the first connection port of the BMC through the second connection port, wherein the response packet conforms to the format of the management interface packet.

8. The management method according to claim 7, further comprising:
transferring a control signal to a fan through the BMC, so as to control a rotational speed of the fan, wherein the fan is coupled to the BMC.

9. The management method according to claim 8, further comprising:
after receiving the response packet, the BMC determining whether a system temperature in the system environment information is higher than or equal to a preset temperature; and
when the system temperature being higher than or equal to the preset temperature, the BMC transferring the control signal to the fan.

10. A rack serving system, comprising:
a rack management server, comprising:
a baseboard management controller (BMC) comprising a first connection port, a management interface packet being transferred through the first connection port;
a storage unit; and
a storage interface coupled to the storage unit, the storage interface comprising:
a second connection port coupled to the first connection port, and configured for receiving the management interface packet; and
a hard disk drive (HDD) controller coupled to the second connection port, and configured for converting the management interface packet into an internal control command that conforms to the storage interface, so as to read a system environment information according to the internal control command, and encapsulating the system environment information into a response packet and transferring the response packet to the first connection port of the BMC through the second connection port, wherein the response packet conforms to the format of the management interface packet.
